(19) United States
(12) Patent Application Publication
(10) Pub. No.: US 2024/0247392 A1
(43) Pub. Date: Jul. 25, 2024

(54) FLUID SEPARATION FOR AN ANODIZING PROCESS

(71) Applicant: ZF Active Safety GmbH, Koblenz (DE)

(72) Inventors: Stefan Schuth, Dieblich (DE); Denis Monpetit, Anschau (DE)

(21) Appl. No.: 18/418,712

(22) Filed: Jan. 22, 2024

(30) Foreign Application Priority Data
Jan. 24, 2023 (DE) 102023101632.6

(51) Int. Cl. C25D 11/02; C25D 11/00; F16D 69/02

(52) U.S. Cl. CPC C25D 11/022; C25D 11/005; F16D 69/02; F16D 2250/0046

(57) ABSTRACT

The present disclosure relates to an anodising system for a component of a motor vehicle brake, comprising an electrolyte source which generates an electrolyte flow along a face to be anodised of the component, and a separating fluid source for generating a separating fluid flow along a face not to be anodised of the component. The disclosure furthermore relates to an anodising method.

### CROSS-REFERENCE TO RELATED APPLICATION

This application claims priority to German Priority Application No. 102023101632.6, filed Jan. 24, 2023, the disclosure of which is incorporated herein by reference in its entirety.

### TECHNICAL FIELD

The present disclosure relates to an anodising system, and in one particular exemplary arrangement, for a component of a motor vehicle brake, comprising an electrolyte source which generates an electrolyte flow along a face to be anodised of the component, and a separating fluid source for generating a separating fluid flow along a face not to be anodised of the component. The disclosure furthermore relates to a method using the anodising system.

### BACKGROUND

Eloxal methods are often used in car production in order to influence surface properties of aluminium components and in particular protect them against wear. For reasons of weight and because of the corrosion resistance, many components of a vehicle brake system are made from aluminium, the mechanical abrasion resistance of which is often insufficient without additional treatment, for example when moving components are received therein, for example displaceable pistons in a piston bore. These regions must have a higher resistance against wear. For component parts of the vehicle brake, however, a wear-minimising surface is not desired on all surfaces, for which reason the anodising should be carried out selectively, i.e. only on a defined part of the surface.

For example, it is necessary for a sealing ball seat not to have a surface coating, since otherwise the material properties and surface quality are negatively influenced and the functional capability of the sealing ball is degraded. One solution possibility is to close such ball seats during the anodising process by closure caps, which are removed again after the eloxal method. The introduction and removal of these closure caps is, however, time-consuming and requires additional process steps. Such closure caps are known for instance from DE 10 2008 027 094 A1.

DE 10 2018 110 905 discloses an apparatus and a method for anodising a component of a brake system, wherein an electrolyte is introduced into a component through an electrolyte inlet and the path of the electrolyte follows a predetermined course. By the selection of the path, only particular regions of the component are anodised.

DE 10 2008 027 094 A1 discloses a housing block for a vehicle brake system, wherein a chamber wall of a chamber of the housing block is selectively surface-treated at least in regions.

### SUMMARY

What is needed is to provide a solution with which selected surface regions of a brake component are intended to be coated as efficiently and flexibly as possible by an eloxal method.

An anodising system for a component of a motor vehicle brake is disclosed herein, comprising an electrolyte source which generates an electrolyte flow from an electrolyte outlet opening along a face to be anodised of the component, and a separating fluid source for generating a separating fluid flow along a face not to be anodised of the component.

An anodising system of the disclosure is used in the car industry in order to manufacture components of a hydraulic motor vehicle brake, for example of a hydraulic control unit (HCU) of a brake control module, such as an integrated brake control module (IBC module). The IBC module is a component part of a motor vehicle brake system, which can generate a braking force desired by the driver and forwards it to the wheels of the motor vehicle. For this purpose, a hydraulic pressure is provided with the aid of an electric motor and a piston/cylinder unit attached thereto. The running face of the piston in the housing must in this case have a predetermined hardness in order to satisfy the service life requirements.

Besides this first recess to be anodised, there are recesses which are not intended to be anodised, for instance valve seats or other surfaces that have already been surface-treated in an upstream production process. For the selective anodising, the present disclosure proposes to provide a separating fluid source in order to generate a separating fluid flow and create a separating fluid barrier which prevents an electrolyte from entering a region that is not to be anodised.

An electrolyte source may be understood as a construction which is configured to generate a flow, such as a fluid flow, of an electrolyte. The electrolyte thereupon follows an electrolyte flow path. In a similar way to this, a separating fluid source is intended to mean a construction which generates a flow of separating fluid that follows a separating fluid flow path.

Starting from an electrolyte source, the electrolyte travels along an electrolyte flow into the component recess to be anodised. The component surface wetted by the electrolyte is in this case converted into a wear-resistant surface and in the case of an aluminium/copper alloy leaches copper into the electrolyte. The electrolyte introduced into the recess to be anodised emerges at a cathode of electrolyte outlet openings, is distributed in the recess to be anodised and is received by an electrolyte sink and removed from the anodising system.

The anodising system also has a separating fluid source for generating a separating fluid flow along a face not to be anodised of the component. The face not to be anodised of the component may in this case adjoin or touch the face to be anodised of the component. For example, the face not to be anodised is a bore that intersects the face to be anodised. The face not to be anodised is for this purpose connected to a separating fluid source which conveys a separating fluid flow into the region to be anodised of the component.

The separating fluid flow creates a separating fluid barrier for the electrolyte, which prevents electrolyte from being able to reach the face not to be anodised. The separating fluid emerging from the face to be anodised is mixed there with the electrolyte that is present to form an electrolyte/separating fluid mixture. Because of the constant electrolyte flow, there is almost exclusively electrolyte at the electrolyte outlet openings; while the electrolyte flows past faces of the component that are not to be anodised, the electrolyte is enriched with separating fluid and the mixing ratio between electrolyte and separating fluid is shifted towards the separating fluid.

Because of the electrolyte/separating fluid mixture varying in the direction of the electrolyte/separating fluid mixture sink, different layer thicknesses of the eloxal method may occur. In one exemplary arrangement, the anodising system therefore comprises a separating fluid feed and electrolyte outlet openings, the electrolyte outlet openings and the separating fluid feeds having an overlap region. By these additional electrolyte outlet openings along the electrolyte path, the electrolyte/separating fluid mixture is enriched with additional electrolyte and a maximally constant concentration of electrolyte in the mixture is thereby ensured. The face not to be anodised may in this case correspond to the separating fluid feed.

The separating fluid may give rise to eddies of the electrolyte, which have a negative effect on the layer thickness. For this reason, the separating fluid feed has an overlap region with the electrolyte outlet opening on the opposite side. The electrolyte emerging from the electrolyte outlet opening in this case creates a pressure that counteracts the opposing separating fluid pressure, so that the interface of the electrolyte is not affected. The inventors have established that by providing one or more of a minimum number of, a maximum spacing between or a minimum flow rate through the electrolyte outlet openings, it is ensured that the separating fluid does not displace the electrolyte so strongly that no eloxal layer occurs, and/or a uniform eloxal layer is achieved.

According to a further exemplary arrangement, the anodising system comprises an electrolyte/separating fluid sink and an anodising container connected to the separating fluid source, the separating fluid source generating a superatmospheric pressure. The electrolyte/separating fluid sink is intended to suction the electrolyte introduced, the electrolyte being mixed with the separating fluid along the flow path and forming an electrolyte/separating fluid mixture. The component to be anodised in the anodising container is fully enclosed by an upper part and a lower part, in which case the upper and lower parts of the housing may be connected to one another tightly with respect to the medium and/or separating fluid and/or air and/or fluid pressure. The medium-tight housing may be connected to the separating fluid source, which thereupon generates a superatmospheric pressure in the anodising container. A constant volume flow of the separating fluid source is necessary since, via the separating fluid feed, separating fluid is constantly discharged via the separating fluid/electrolyte sink.

According to a further aspect of the disclosure, the electrolyte outlet opening has an opening edge profile which is profiled in such a way that the electrolyte outlet region is widened. Because of the geometrical configuration of the region to be anodised, it may be necessary for the opening edge profile of the electrolyte outlet opening to have a profiled contour in order to allow a consistent layer thickness by the eloxal method. Corners and undercuts represent a challenge for the eloxal method. Separating fluid accumulation occurs in these regions, so that an eloxal method cannot take place at these locations.

By the opening edge profiling, an increased turbulence of the emerging electrolyte may be achieved so that even remotely lying separating fluid accumulations are disrupted. In any event, homogeneous mixing of the electrolyte and the separating fluid has a significant influence on the eloxal method. Different opening edge profiles may be envisaged in this case, and the profile may for example be an undulating structure at the electrolyte outlet opening.

According to a further aspect of the disclosure, the electrolyte source has a plurality of electrolyte outlet openings. By the additional electrolyte outlet opening, it is possible to influence the electrolyte/separating fluid mixture, and to increase the proportion of electrolyte along the electrolyte flow. The electrolyte outlet openings may for this purpose be applied at different locations of the cathode, for example, symmetrically along the longitudinal extent direction of the cathode.

The additionally introduced electrolyte outlet openings may in this case be applied radially with respect to the longitudinal extent direction of the cathode, but may also have an angle with respect to the latter. For example, the additional electrolyte outlet openings are aligned in an opposite direction to the electrolyte path so that an additional turbulence can be generated, which can disrupt separating fluid accumulations.

According to a further exemplary arrangement, the separating fluid mass flow, separating fluid pressure, electrolyte mass flow as well as voltage and current of the eloxal method have a profile as a function of time. For example, with these parameters the eloxal layer thickness and the electrolyte/separating fluid mixture may be influenced and adapted to the existing circumstances.

### BRIEF DESCRIPTION OF DRAWINGS

According to a further aspect of the disclosure, a method for separating metals dissolved during an eloxal method is provided. According to the disclosure, a high efficiency is achieved during the anodising in that dissolved metals can be filtered from the electrolyte and optionally sent for recycling. Further features, advantages and properties of the disclosure will be explained with the aid of the description of an exemplary arrangement of the disclosure with reference to the figures, in which:

FIG. 1: shows a sectional view of an anodising system of the disclosure with an inserted component to be anodised, cathode and electrical contacting;

FIG. 2: shows the anodising system according to FIG. 1 with a separating fluid along a face not to be anodised;

FIG. 3: shows an isometric arrangement of an aluminium valve module housing with recesses to be anodised and not to be anodised;

FIG. 4: shows a cathode arrangement of the disclosure with electrolyte outlet openings and an electrolyte source and electrolyte/separating fluid mixture sink;

FIG. 5A: shows a cathode arrangement having a crown-shaped electrolyte outlet opening;

FIG. 5B: shows a development of the cathode arrangement with additional outlet openings;

FIG. 5C: shows a cathode arrangement with a multiplicity of electrolyte outlet openings;

FIG. 6: shows an anodising system of the disclosure with a separating fluid connection and electrical contacting; and

FIG. 7: shows a production system with a copper separator and anodising cells.

### DETAILED DESCRIPTION

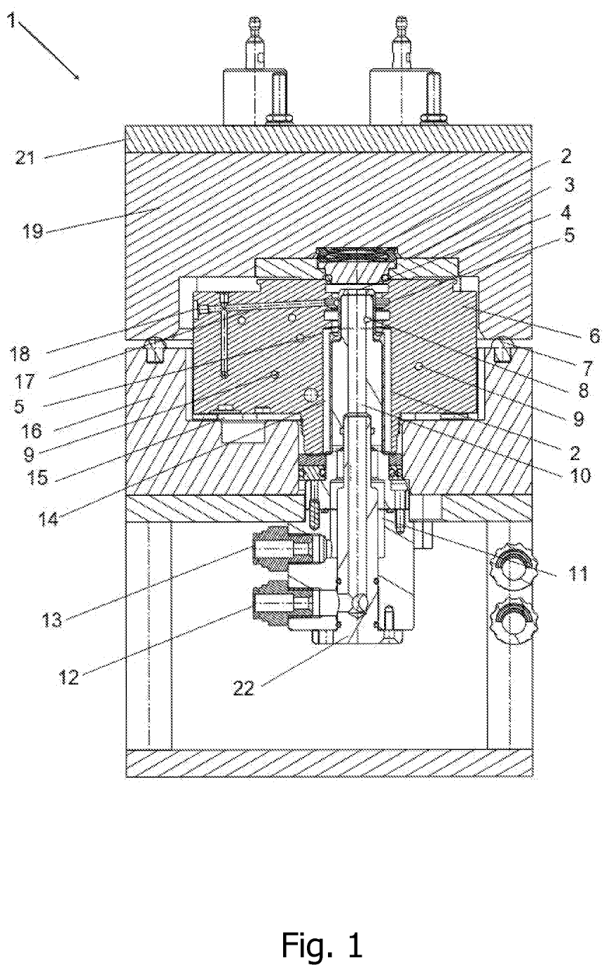

FIG. 1 shows a sectional representation of an anodising system 1 of the disclosure, such as may be used in an anodising process. The anodising system 1 comprises a lower and an upper housing 19, which can be connected fluid-tightly to one another by a sealing strip 7. Both the upper and lower housing 16 may be constructed of nonconductive materials, for instance plastics, in order to avoid electrical conduction between an anode and cathode 22.

The anodising system 1 contains a component 6, 100 to be anodised, which is located on centring elements 15 on the lower housing part and is pressed onto the centring element 15 by a corrugated spring 2 that is located in the upper housing part. Centring of the component 6, 100 to be anodised in the anodising system 1 is crucial for a consistent layer thickness of the eloxal method. Centring is likewise necessary in order to be able to fit the cathode 22 into the component 6, 100 to be anodised. The corrugated spring 2 ensures flush bearing of the component 6, 100 to be anodised on the centring element 15 during the processing.

Besides the recess to be anodised, the component 6, 100 to be anodised also has blind bores 9. Blind bores 9 are bores which extend through the component 6, 100 to be anodised without being intended to be surface-treated. These blind bores 9 are used to convey brake fluid in the finished brake system. In addition, the component 6, 100 to be anodised may have at least one bore which intersects the face 5 to be anodised. This at least one bore may have a sealing ball seat 18 which is not intended to be anodised. A separating fluid barrier 20 is therefore intended to be formed inside the bore in which the separating fluid flows. This separating fluid barrier 20 separates the region to be anodised from the region not to be anodised.

A cathode 22 is inserted into the recess 101 to be anodised of the component 6, 100 to be anodised. This cathode 22 has an electrolyte source 12, via which electrolyte is introduced into the cathode 22 and flows along an electrolyte flow 10 to the electrolyte outlet openings 4. The electrolyte outlet openings 4 may in this case extend lengthwise or transversely along a midaxis of the cathode 22. When the electrolyte has emerged into the electrolyte outlet openings 4, it is mixed with the separating fluid flowing in through the separating fluid flow to form an electrolyte/separating fluid mixture. This mixture flows along the face 5 to be anodised of the component 6, 100 to be anodised in the direction of the electrolyte/separating fluid sink 13.

By contacting of the component 6, 100 to be anodised with the anode, an electrical circuit is created and the eloxal method begins. As a result of the further delivery of electrolyte by the electrolyte source 12 and the further delivery of separating fluid by the separating fluid source 301, the electrolyte/separating fluid mixture is expelled from the recess to be anodised and accumulates in an electrolyte collection reservoir. From the latter, it travels to the electrolyte/separating fluid sink 13.

So that the cathode 22 is seated centrally in the recess to be anodised of the component 6, 100 to be anodised, a fit is provided. In addition, the cathode 22 is connected tightly with respect to separating fluid in relation to the lower housing.

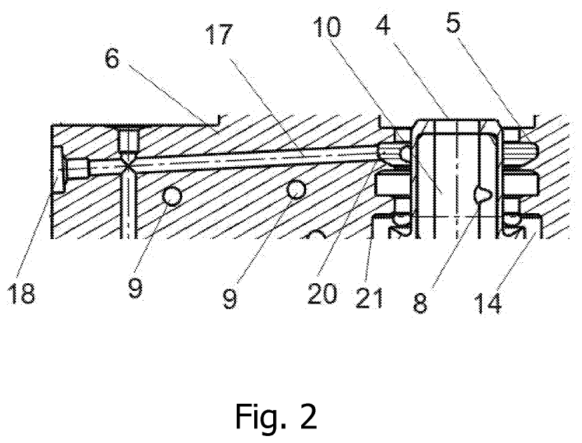

FIG. 2 shows the anodising system according to FIG. 1, which is intended to show the transition from the separating fluid to the electrolyte. The electrolyte rising via the cathode 22 emerges at electrolyte outlet openings 4, in quantitative terms the outlet opening being the largest in area along the longitudinal extent direction of the cathode 22. The sectional electrolyte outlet opening 8 has an orientation that does not correspond to the plane of the drawing and is therefore visible only as a triangle. This sectional electrolyte outlet opening 8 may be arranged opposite another separating fluid flow 17 (not shown).

The separating fluid introduced via the separating fluid source 301 passes through the sealing ball seat 18 and flows along the separating fluid flow 17 to the electrolyte. A separating fluid barrier 20 for the electrolyte is intended to be created along the separating fluid flow 17, or the bore of the latter. In the exemplary arrangement shown, the location of the bore at which this barrier is formed is irrelevant since it is only important that the sealing ball seat 18 is not subjected to an eloxal method. In one exemplary arrangement, the separating fluid barrier 20 is set up at the position marked. Besides the view shown, the component 6, 100 to be anodised may have additional sealing ball seats 18 and separating fluid flows that lie in other planes.

As may be seen in FIG. 2, there is only electrolyte directly at the electrolyte outlet opening 4 along the longitudinal extent direction of the cathode 22, which is enriched with separating fluid on the way to the sink. Along the flow direction, the electrolyte is mixed with overflowing separating fluid and forms an electrolyte/separating fluid mixture. In order to increase the amount of electrolyte in the electrolyte/separating fluid mixture, further electrolyte outlet openings 4 may be provided along the flow direction.

It is advantageous for the electrolyte outlet openings 4 to be spatially arranged opposite the separating fluid flows. The electrolyte flowing out then acts against the separating fluid flowing from the opposite direction, and no contact takes place between the face 5 to be anodised and the separating fluid.

The entire region between the upper and lower housing 16 is filled with the separating fluid. Since there are only isolated bores between the recess to be anodised and the interior of the anodising system 1, separating fluid passes over into the electrolyte bath only at selected bores. The blind bores 9 are therefore also filled with separating fluid, although this has no effects on the method of the disclosure since no current flows here and an anodising process therefore does not take place.

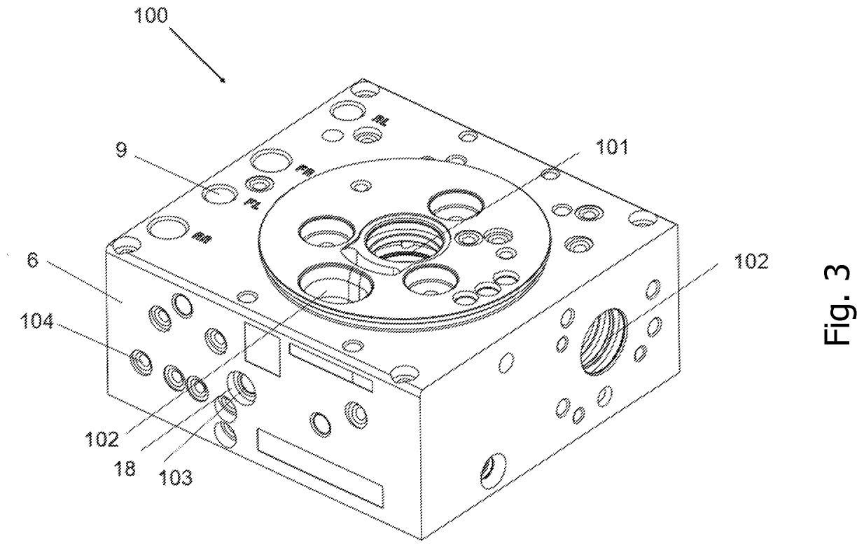

FIG. 3 shows an isometric view of the component 6, 100 to be anodised. As may be seen in the figure, the component 6, 100 to be anodised has a first recess 101 to be anodised, which is already known from FIG. 1. Other recesses 102 to be anodised are furthermore represented, which are likewise anodised in a downstream process step. It is also possible for a plurality of anodising methods to be carried out, simultaneously in one direction via a plurality of cathodes 22. By the parallel anodising of a plurality of recesses to be anodised, the method gains a cost advantage over sequential anodising. The anodising system 1 of the disclosure and the anodising method of the disclosure may be carried out for all the recesses shown. For this purpose, however, the upper and lower housing as well as the centring elements 15 need to be adapted to the respective circumstances and the recess 101 to be anodised.

FIG. 3 additionally shows a sectional bore which has a section with at least one recess to be anodised. This sectional bore 103 corresponds to a bore in which the separating fluid flows in the direction of the face 5 to be anodised. This sectional bore 103 likewise has a sealing ball seat 18. Blind bores 104, which have no intersection with a recess to be anodised, are likewise shown.

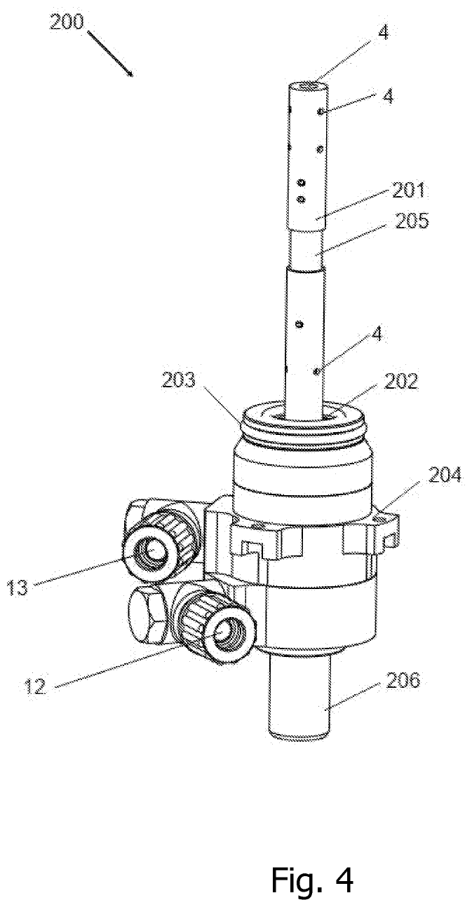

FIG. 4 shows a cathode 22 which may be used for the anodising system 1 of the disclosure. Electrolyte enters the cathode 22 via the electrolyte source 12, rises along the longitudinal axis of the cathode 22 and emerges through electrolyte outlet openings 4. These electrolyte outlet openings 4 may be placed at various locations of the cathode 22. For example, it is expedient to arrange electrolyte outlet openings 4 opposite separating fluid bores.

The electrolyte outlet openings 4 may also be arranged in such a way that an additional turbulence is introduced into the electrolyte/separating fluid mixture in order to avoid the accumulation of separating fluid in particular regions. The arrangement of the electrolyte overflow bores may in this case be adapted to the component 6 to be anodised. Alternatively, the tubular construction with the applied electrolyte outlet openings 4 may be detachably connected to the cathode 22. Different electrolyte outlet opening tubes may therefore be connected to the cathode 22.

In addition, the cathode arrangement 200 has an insulating jacket 201 in the region of the electrolyte outlet openings 4 in order to avoid electrical contacting with the anodised component 6, 100.

After the electrolyte/separating fluid mixture has flowed along the face 5 to be anodised in the direction of the suction opening 202, it travels through an annular gap to the electrolyte/separating fluid sink 13. The cathode 22 may be mounted on the lower housing, the cathode 22 having a cathode seal 203 and a fastening flange 204 in order to provide accurate positioning and tight connection.

Since it is necessary to apply a voltage for the eloxal method, the cathode 22 must have electrical contacting. The position of the electrical contacting may in this case be selected freely, a position that is highly accessible being advantageous.

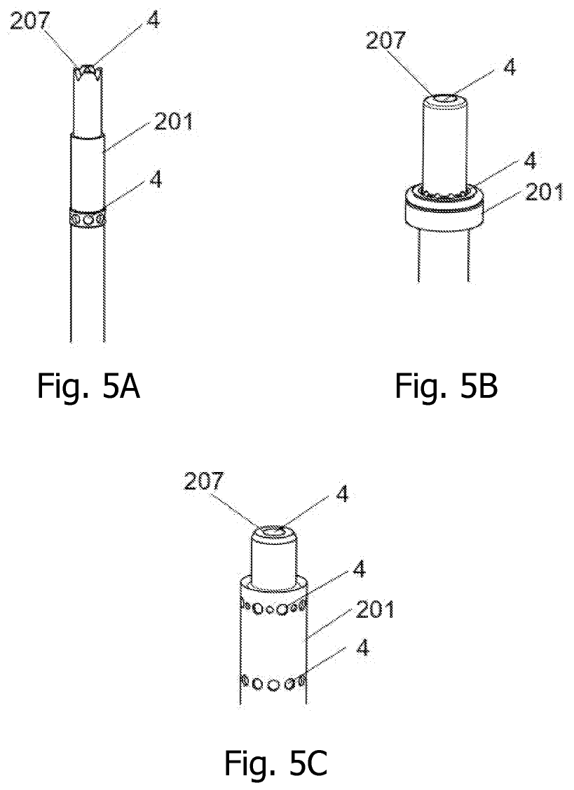

FIG. 5A shows an exemplary arrangement of an electrolyte riser line 205 with various electrolyte outlet openings 4. The opening edge profile 207 of the first exemplary arrangement in this case has a crown-shaped structure which extends along the longitudinal extent direction of the cathode 22. The crown-shaped configuration has the advantage that additional turbulences are introduced into the electrolyte, so that good mixing with the separating fluid is ensured.

In addition, even far-removed regions of the recess to be anodised can be reached by the additional turbulences. Undercuts and sharp corners are reached well with a crown-shaped electrolyte outlet opening 4. In the circumferential direction of the electrolyte riser line 205, further electrolyte outlet openings 4 which have an equal spacing from one another are applied. By this arrangement, a pointwise increase of the proportion of electrolyte in the electrolyte/separating fluid mixture may be achieved.

FIG. 5B shows an exemplary arrangement of an electrolyte riser line 205 with electrolyte outlet openings 4 applied thereon. In this exemplary arrangement, the electrolyte outlet openings 4 are opposed to the flow of the separating fluid/electrolyte mixture. This alignment of the electrolyte outlet openings 4 allows an additional turbulence and an increased surface quality due to the eloxal method. The local velocity of the electrolyte may thereby also be influenced.

FIG. 5C shows a further exemplary arrangement of an electrolyte riser line with electrolyte outlet openings 4 applied thereon. In this case, the electrolyte outlet openings 4 are applied radially with respect to the longitudinal extent direction of the electrolyte riser line 205, similarly to in FIG. 5A. A variation of the bore diameters of the electrolyte outlet openings 4 likewise has a positive influence on the surface quality of the eloxal method. FIG. 5C likewise shows that the diameter of the electrolyte riser line 205 may be varied in order to satisfy the requirements of the recesses to be anodised. By the additional electrolyte outlet openings 4, the surface quality and material properties of the face 5 to be anodised may be improved pointwise.

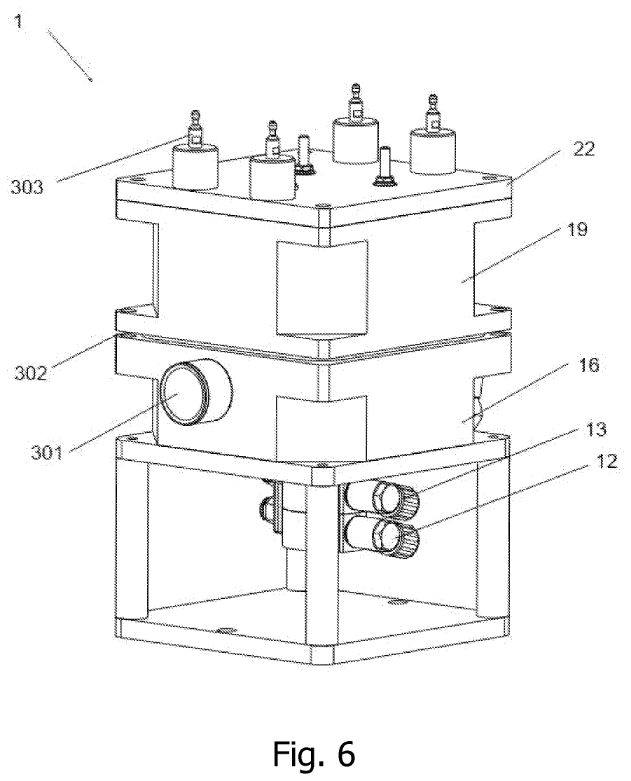

FIG. 6 shows an isometric view of an anodising system 1 of the disclosure. The anodising system 1 is already in a closed arrangement and is also provided with the cathode 22, so that the system is ready for operation. For the electrical contacting of the component 6, 100 to be anodised, anode connections that can be connected to the component being anodised are provided on the anodising system 1. For the connecting of the closure plate 21 to the upper housing, or for the connecting between the upper housing and the lower housing 16, dowel bores with pins are provided, which are used so that the components achieve a predetermined setting with respect to one another. Displacement of the components is therefore no longer subsequently possible.

A separating fluid source 301 is also provided on the anodising system 1, via which the separating fluid, for example compressed air and/or an inert gas, or an unreactive gas, can be attached. Via this connection of the separating fluid source 301, the separating fluid travels between the upper and lower housing 16 and from there via the bores not to be anodised to the face 5 to be anodised, and from there into the electrolyte. FIG. 6 also shows the electrolyte source 12 and the electrolyte/separating fluid sink 13.

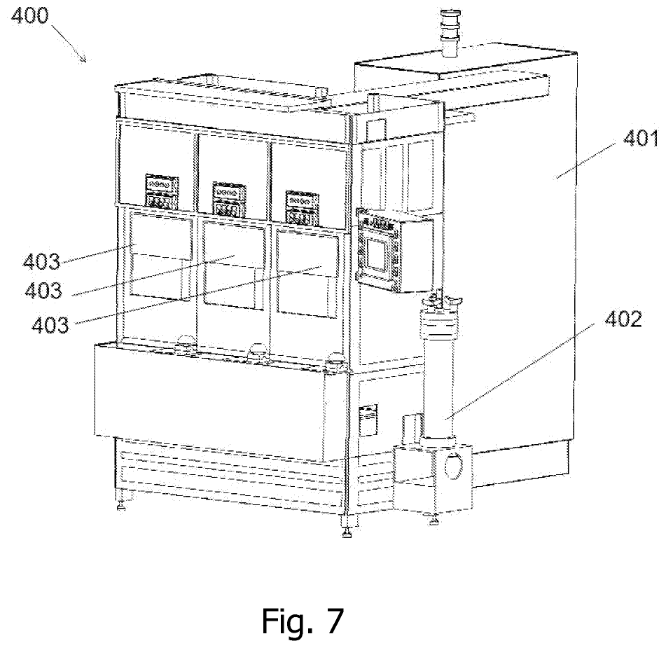

FIG. 7 shows a production system 400 such as may be used in production. A production system 400 may have a multiplicity of electrolyte provision systems 401, which supply a multiplicity of anodising cells 403. Each of these anodising cells 403 may in this case have at least one anodising system 1 of the disclosure. In order to separate the copper dissolved from the aluminium alloy of the element to be anodised during the anodising method, a copper separator 402 is provided.

According to the method of the disclosure for separating metal dissolved during an eloxal method, an electrolyte/copper mixture is discharged from the recess of the component, the electrolyte/copper mixture is conveyed to a separating device, the separating device is supplied with electrical energy, and the copper contained in the electrolyte/copper mixture is filtered out.

The object described above is likewise achieved by a method using the anodising system 1 above, in which the component is provided; a cathode 22 is introduced into a recess of the component; an upper and lower housing 16 are closed medium-tightly and a separating fluid region is provided; the cathode 22 and the component are contacted with a current supply and the electrolyte emerges at electrolyte outlet openings 4, the face 5 to be anodised of the component is wetted with electrolyte; a separating fluid barrier 20 is formed by the separating fluid flowing over in the region between an overflow bore and the recess; and the electrolyte/separating fluid mixture is suctioned on the entry face of the recess.

From the feature combinations disclosed here, isolated features may optionally also be selected and used in combination with other features while omitting a structural and/or functional context possibly existing between the features in order to delimit the claimed subject matter. The sequence and/or number of steps of the methods may be varied. The methods may be combined with one another, for example in order to form an overall method.

1. An anodising system for a component of a motor vehicle brake, comprising; an electrolyte source which generates an electrolyte flow from an electrolyte outlet opening along a face to be anodised of the component, wherein a separating fluid source generates a separating fluid flow along a face not to be anodised of the component.

2. The anodising system according to claim 1, wherein the anodising system has a separating fluid feed, the separating fluid feed comprising an anodising container into which the component can be inserted, and/or the separating fluid feed comprising the component.

3. The anodising system according to claim 1, wherein the anodising system comprises a separating fluid feed and the electrolyte outlet opening, the electrolyte outlet opening and the separating fluid feed having an overlap region.

4. The anodising system according to claim 1, wherein the anodising system comprises an electrolyte/separating fluid sink and an anodising container connected to the separating fluid source, the separating fluid source generating a superatmospheric pressure.

5. The anodising system according to claim 1, wherein the anodising container is configured to be separating fluid-tight.

6. The anodising system according to claim 1, wherein the electrolyte outlet opening has an opening edge profile which is profiled in such a way that the electrolyte outlet region is widened.

7. The anodising system according to claim 1, wherein the electrolyte source has a plurality of electrolyte outlet openings.

8. The anodising system according to claim 7, wherein the number of electrolyte outlet openings increases in the flow direction of the electrolyte flow path.

9. A method of using the anodising system according to claim 1 for anodising a component of a motor vehicle brake, comprising an electrolyte source which generates an electrolyte flow from an electrolyte outlet opening along a face to be anodised of the component, and a separating fluid source for generating a separating fluid flow along a face not to be anodised of the component, the method comprising:
providing the component,
introducing a cathode into a recess of the component,
closing an upper and lower housing (19, 16) are medium-tightly and providing a separating fluid region,
contacting the cathode and the component with a current supply such that the electrolyte emerges at electrolyte outlet openings, the face being anodised of the component is wetted with electrolyte,
forming a separating fluid barrier by the separating fluid flowing over in a region between an overflow bore and a recess,
and suctioning the electrolyte/separating fluid mixture on the entry face of the recess.

10. The method according to claim 9, wherein by control of a compressed air mass flow, air pressure, electrolyte mass flow, a current and a voltage in the profile as a function of time.

11. The method for separating metals dissolved during an eloxal method, using the anodising system according to claim 1, wherein:
an electrolyte/copper mixture is discharged from a recess of the component,
the electrolyte/copper mixture is conveyed to a separating device,
the separating device is supplied with electrical energy,
and the copper contained in the electrolyte/copper mixture is filtered out.

12. The anodising system according to claim 2, wherein the anodising system comprises a separating fluid feed and the electrolyte outlet opening, the electrolyte outlet opening and the separating fluid feed having an overlap region.

13. The anodising system according to claim 12, wherein the anodising system comprises an electrolyte/separating fluid sink and an anodising container connected to the separating fluid source, the separating fluid source generating a superatmospheric pressure.

14. The anodising system according to claim 12, wherein the anodising container is configured to be separating fluid-tight.

15. The anodising system according to claim 12, wherein the electrolyte outlet opening has an opening edge profile which is profiled in such a way that the electrolyte outlet region is widened.

16. The anodising system according to claim 14, wherein the electrolyte source has a plurality of electrolyte outlet openings.

17. The anodising system according to claim 14, wherein the number of electrolyte outlet openings increases in the flow direction of the electrolyte flow path.
